(19) United States
(12) Patent Application Publication
(10) Pub. No.: US 2008/0010453 A1
(43) Pub. Date: Jan. 10, 2008

(54) Method and apparatus for one time password access to portable credential entry and memory storage devices

(76) Inventor: Laurence Hamid, Ottawa (CA)

Correspondence Address: FREEDMAN & ASSOCIATES, 117 CENTREPOINTE DRIVE, SUITE 350, NEPEAN, ONTARIO, K2G 5X3, omitted

(21) Appl. No.: 11/480,969

(22) Filed: Jul. 6, 2006

(51) Int. Cl. H04L 9/00

(52) U.S. Cl. 713/159

(57) ABSTRACT

A method is disclosed wherein a user is provided with a replacement one-time password or secure transfer key for re-establishing secure access to information contained within at least one of peripheral memory storage device, a system to which the peripheral memory storage device is connected, or a system to which the peripheral memory storage device is remotely connected. The peripheral memory storage device containing the necessary additional security keys and processes to establish the new access rights in response to the one-time password or transfer key presented. No digital transmission from the peripheral memory storage device is undertaken thereby providing a self-contained security process without interception, decryption, re-working or hacking of remotely stored password information.

### FIELD OF THE INVENTION

The invention relates to the field of computer security and more particularly to the field of enhanced password security in portable security credential and memory storage devices.

### BACKGROUND OF THE INVENTION

In recent years, there has been growing use of security architectures whereby the user is required to provide multiple credentials at different stages of logging onto microprocessor based systems such as personal computers (PCs), Internet terminals and personal data analyzers (PDAs). In the simplest form these credentials are a user identity, which is checked against a list of valid user identities stored within the system, and a password, which is validated against stored data relating to the user identity to verify the user identity. In these instances entering the requisite information—logging on or login—is a physical event, most commonly the typing of both user identity and password using a symbol entry device such as a keyboard attached to the system.

Typically both the user identity and password are simple alphanumeric codes for the user to remember and consequently, they were often easily guessed or determined. This is exacerbated when using multiple computer systems, software applications, and even having multiple security access levels based upon their activities and location. As such a person has a large number of passwords, for example for accessing a home computer, a work computer, Internet banking, music downloads, electronic mail, secured files, encryption keys, and online auction sites amongst the most common ones.

Historically a user memorizes these passwords, writes then down, stores them on their computer, or synchronizes them all so that they are all the same. This has led to the prior art approaches based upon either providing additional software applications that allow a portable security key to automatically store login data and provide this based upon a single top level security entry, i.e. a master password). This obviously makes the security of an individual's personal information quite weak allowing others to rapidly access said information and use it once giving them access to everything the individual access. Hence, this has been the basis of the criminal activity commonly known as “identity theft” but has also been core to many industrial espionage and knowledge thefts. As a result there have been a number of developments and commercial products based upon biometric verification such as fingerprint, voice, and retinal image.

The continuing advances in semiconductor circuit design, resulting in the density of memory circuits continuing to advance whilst power requirements have decreases, has led to the rapid proliferation of uses of semiconductor memory including the provision of portable solid state memory devices. Today, solid-state memory is packaged within many physical formats as the basic function is overtaken by fashion, style and marketing. The most common forms of solid-state memory are the USB (Universal Serial Bus) memory “key” or “stick” for interfacing with a USB port of a host computer system, and flash memory cards inserted into dedicated card readers.

Thus at this time there has been a merging of the two streams of technical development such that USB memory sticks are now commercially available with integrated fingerprint sensors allowing for enhanced security protection of both information stored on the USB memory stick but also user identities, passwords and security credentials stored within it even when these are hidden.

At present, for users accessing their data and systems without these latest high-tech and costly devices, the loss of a password is generally addressed by the resending of the password from a central office after the user has submitted either verbally or electronically responses to security questions. This means that at the central office are a list of passwords to all users, causing issues of integrity and security of both the files stored external to the user at the central office and the security of communications as their existing or new password is sent to them electronically.

Similar issues exist for users of the improved high-tech devices, but again issues over passwords and security credentials are approached from the basis of sending electronically from the user to the central office responses to security questions and receiving either the existing or a replacement password. Again this is open to interception and abuse. Additional problems exist for the USB memory key and other similar memory devices, which include biometric verification. Here, for example fingerprint sensor verification blocks the user access if they cut or burn the finger providing verification. In fact to prevent fraud, theft some systems now recognize that finger is attached to an individual by secondary sensors measuring pulse or temperature. Thus injury can prevent legitimate access in addition to fraudulent and criminal access.

These systems also present issues in the event of the death of the user preventing a business legitimately accessing the users information, or for a business to verify that the employee is not stealing or illegally transferring information. It would be further advantageous for transferring secure information to exploit the physical transfer aspects of memory keys but restricting the access of one or more users providing the information to the memory keys.

It would therefore be advantageous to provide a method that allows for the business enterprises to perform legitimate access recovery and verification in addition to allowing a user re-establishment of secure access to either security credentials or information without requiring the transmission of security key information, which may be intercepted. It would also be advantageous if the solution allowed for multiple levels of security access allowing for example the business IT department “super-user access” to everything on the memory key, whilst providing the employee with normal access to the memory key, and perhaps a guest access such that key can be accessed for read-only to all or limited information.

### SUMMARY OF THE INVENTION

In accordance with the invention there is provided a security process for securing at least a part of information stored upon a peripheral memory storage device. The security process comprising a one time password access protocol for providing a secondary secure access protocol to the peripheral memory storage device. The peripheral memory storage device already possessing an existing primary secure access protocol. The secondary secure access protocol for operating independent of the information for initiating the primary secure access protocol and further being absent of a means for exposing information useful for breaching either the primary secure access protocol or the second secure access protocol. The secondary secure access protocol comprising the contacting a one time password provider, the one time password provider at least one of a server and an information technology administrator. The user identifies themselves to the one time password provider; and receives from the one time password provider a one time password for use with the secondary secure access protocol, the one time password for providing access one time.

In accordance with another embodiment of the invention there is provided a security process for securing at least a part of information stored upon a peripheral memory storage device. The security process comprising a one time password access protocol for providing a secondary secure access protocol to the peripheral memory storage device. The peripheral memory storage device already possessing an existing primary secure access protocol. The secondary secure access protocol for operating independent of the information for initiating the primary secure access protocol and further being absent communication between the peripheral memory storage device and an external electronic system. The secondary secure access protocol comprising the contacting a one time password provider, the one time password provider at least one of a server and an information technology administrator. The user identifies themselves to the one time password provider; and receives from the one time password provider a one time password for use with the secondary secure access protocol, the one time password for providing access one time.

In accordance with another embodiment of the invention there is provided a security process for securing at least a part of information stored upon a peripheral memory storage device. The security process comprising a transfer key access protocol for providing a secondary secure access protocol to the peripheral memory storage device. The peripheral memory storage device already possessing an existing primary secure access protocol. The secondary secure access protocol for operating independent of the information for initiating the primary secure access protocol and further being absent of either communication between the peripheral memory storage device and an external electronic system or a means for exposing information useful for breaching either the primary secure access protocol or the second secure access protocol. The secondary secure access protocol comprising the contacting an access key provider, the access key provider at least one of a server and an information technology administrator. The user identifies them self to the access key provider; and receiving from the access key provider a transfer key for use with the secondary secure access protocol, the transfer key for providing an access key, the access key for accessing the peripheral memory storage device.

### BRIEF DESCRIPTION OF THE DRAWINGS

Exemplary embodiments of the invention will now be described in conjunction with the following drawings, in which:

FIG. 1 illustrates a typical prior art configuration for the use of secure, one-time passwords during password-protected system reboot.

FIG. 2 illustrates an exemplary simplified flow diagram for implementing the invention illustrating the secondary access path with a one-time password.

FIG. 3 illustrates an exemplary simplified flow diagram for implementing a first embodiment of the invention and illustrating both access denial and provision of multiple levels of security access.

FIG. 4 shows a simplified block diagram of a peripheral memory storage device.

FIG. 5 illustrates an exemplary simplified flow diagram for implementing a second embodiment of the invention illustrating the use of a one-time password and multiple access keys.

### DETAILED DESCRIPTION OF EMBODIMENTS OF THE INVENTION

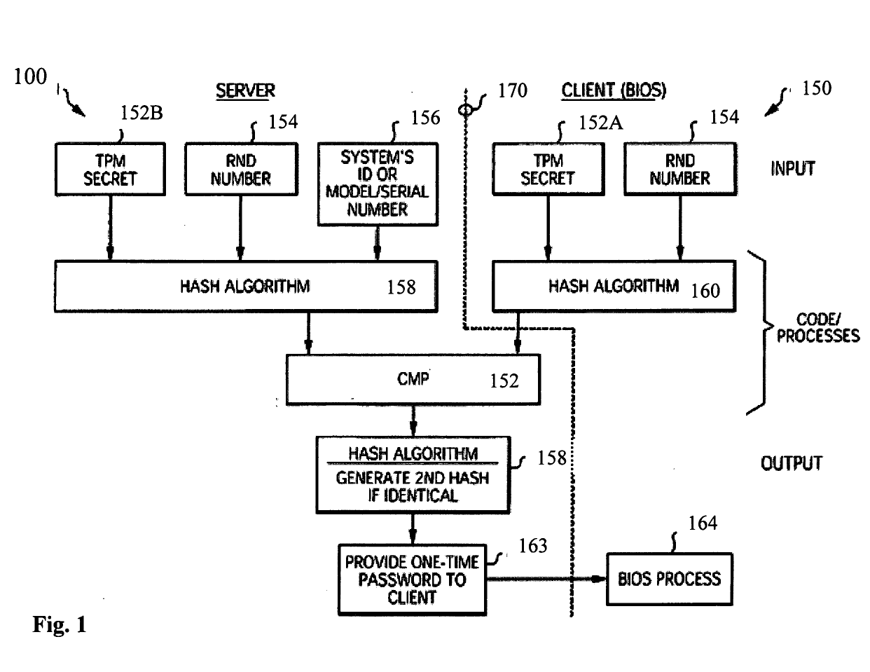

Referring to FIG. 1 illustrated is a prior art process by which a one-time password is generated and utilized. Some of the functional features of the prior art approach are programmed into the BIOS of the computer system, and as shown are implemented at the client side 151. Other functional features are programmed into the server at the server side 150 of the process. For simplicity of description the programmed server-side features are assumed as carried out by a password generation utility.

Notably both client-side 151 and server-side 150 processes include the hashing-algorithm 160 and 158 which take as input data at least the trusted platform module (TPM) secret—administrative password—152A, 152B and the generated random number 154. Each side maintains a copy of the TPM secret (i.e. 152A at client side 151 and 152B at server side 150) in a secure location, while the random number 154 is generated at the computer system and passed to the server side 150 during transfer of data to initiate the generation of the one-time access password.

In addition to these values, server side 150 executes hash process 158 that also takes system authentification and identification parameters 106 as input data thereto. These parameters 106 are passed to the server side 150 from the client side 151 and are utilized to complete a validation of the person requesting the one-time access for password reset who is the authorized user. The system authentification or identification parameters are transmitted from the client side 151 to server side 150 at or around a time the random number is transmitted.

Both hash processes 160, 158 generate results that are passed through a comparator 162 at the server side 150 and the result 114 determines whether the one-time access password is generated. At that time when authorized, the TPM secret 102B is hashed with the generated hash at the server side 108 using the hash process 158. The resulting one-time password 163 is transmitted to the client, where the password is entered into a BIOS process 164 to access the system and files.

It would be evident to one skilled in the art that the prior art embodiment described for providing one-time access passwords does not address the limitations and drawbacks outlined previously. Most notably the approach requires bi-directional transmission of password and client verification data. Secondly, once provided, the OTP provides unfettered access to the system allowing an illegal user to firstly gain access to the system or files and then adjust the password/access process to their own ends. Finally, the prior art system is poorly suited to use with biometric access wherein forgetting a password is not an issue and therefore, resetting of same absent supervision is typically considered undesirable.

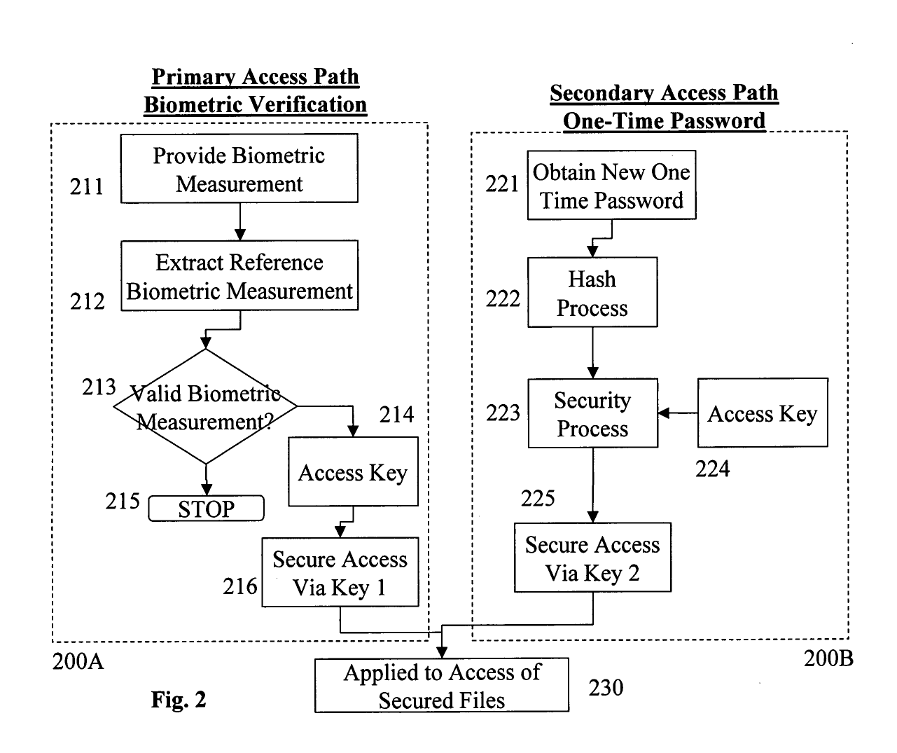

Referring to FIG. 2 an exemplary simplified flow diagram of an embodiment of the invention is shown. A first security process 200A is in execution wherein a user operating a removable peripheral memory storage device such as USB memory stick is subjected to biometric verification of the user prior to granting access to data stored therein. Upon coupling the USB memory stick to a computer (not shown for clarity) for accessing data stored therein, a user is prompted to provide biometric information at 211. Typically, biometric information is sensed with a biometric sensor such as a fingerprint sensor providing biometric data in response to the sensed biometric information. The sensed biometric data is then processed to determine comparison data therefrom. Internally stored biometric template data is then retrieved within the peripheral memory storage device at 212. This is then compared in process 213 with the comparison data. When the data are outside of acceptable limits of each other, the process stops in a stop process 215 preventing access to the data stored within the peripheral memory storage device. When the data are within acceptable limits of each other, the access key is provided by process 214 for allowing access to the data. Typically the access key is stored in an obfuscated fashion such as in an encrypted fashion.

Now, in this illustration the user has little control over the access code or the access methodology. For example when the user fingertip is not imageable, due for example to plaster or dirt on their fingertip, and preventing a fingerprint verification process in steps 211 through to 213 from authenticating the user and thus always resulting in the stop process 215, it is possible that enrollment of the user's fingerprint may repeatedly fail. Further, the user is not able to simply change their password, as an enrollment process is necessary for fingerprint verification. Here, a user wishes to gain access to the data within their portable storage medium but also wishes to retain their fingerprint enrollment as their fingerprint will function at a later time.

The user contacts an information technology, IT, department and provides the necessary user authentification such that the IT department provides a one-time password (OTP) at process 221. Unlike prior art embodiments there is no electronic transfer of passwords from the user side to the server (central office) side as part of either process 200A or 200B. The one-time password is entered during process 221 and is now hashed by process 222 to generate a hashed one-time password, H(OTP), which is now entered into the security process 213 alongside the access key from process 214.

In this embodiment, as for most embodiments of the invention, the access key is stored locally to the user in a hidden manner upon a removable peripheral memory storage device. The security process 213 operating in a typical manner as follows:

SECURITY {H(OTP);(Access Key)}=Security-Access-Key-2

### This thereby provides “Security-Access-Key 2” at process 215, which is employed in accessing the system or information at process 230 for each required access to stored data.

It would be evident to one skilled in the art that this process has many of the advantages outlined for secure access to either fixed or removable storage media and systems in that there is no transfer of the password initially or at any later date from the user to the central office, and hence no potential intercept or subsequent extraction from central office files, and that there is no possible correlation in the access key since it is never transmitted either in raw or secured format. Equally there is no storage of the hashing codes as they are generated internally to the peripheral memory storage device at the time of use.

It is a further advantage of the embodiment that it provides a secondary, or backdoor, access into the removable peripheral memory storage device alongside the primary and conventional access approach. It is useful with a wide variety of removable peripheral memory storage devices; it is optionally activated or deactivated at release of a removable peripheral memory storage device by a vendor, business or central administrator. Further it is optionally implemented to be compatible to the full existing inventory or deployed base of removable peripheral memory storage devices of a vendor or business.

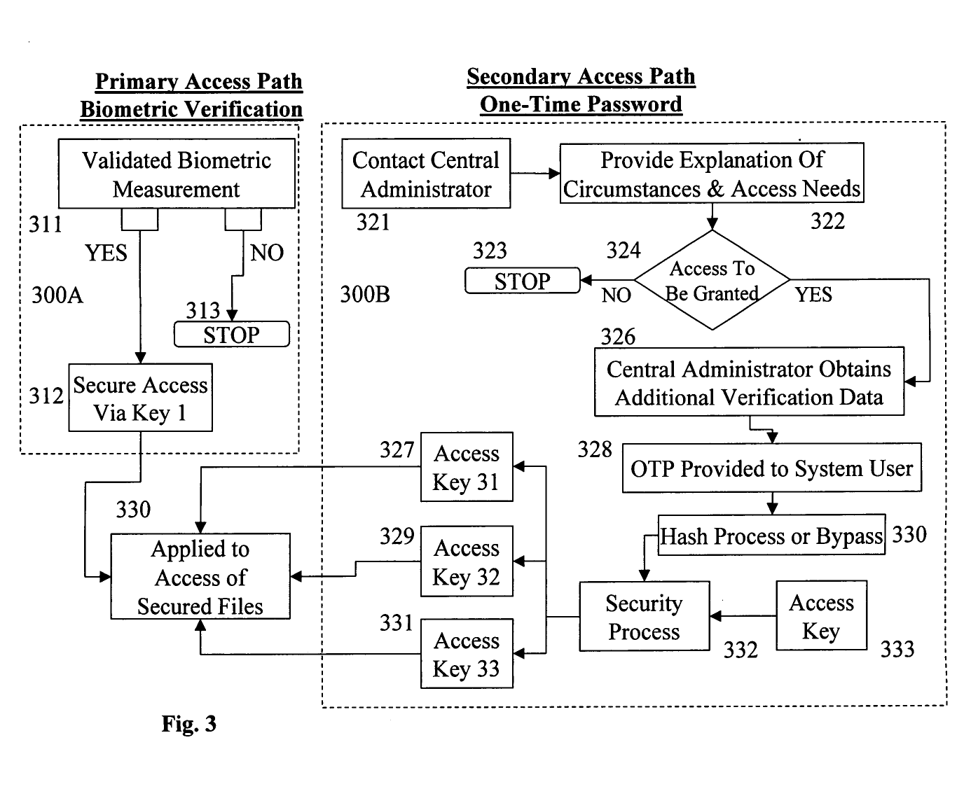

Referring to FIG. 3 shown is an exemplary simplified flow diagram illustrating both access denial and provision of multiple levels of security access using different one time generated passwords.

A first process 300A represents the normal path of accessing a peripheral memory storage device in the form of a USB memory key enabled with fingerprint verification. Here the user provides a fingerprint sample at 311 wherein access rights of the user for the secure data are determined. An invalid verification of the provided fingerprint sample against stored template data results in a stop process 313. An authenticated fingerprint results in extracting an access key “key 1” in process 312 which is then provided to result in access to the secured files in process 330.

If the validation process 311 results in the stop process 313, for example because of temporary or permanent damage to a fingertip, then the user initiates process 300B by contacting a central administrator or a central administrator process in process 321. The user is typically required by the central administrator to provide an explanation of the circumstances and the access required in process 322. The central administrator then determines in process 324 whether to provide access or not. If not then the process stops with process 323. By way of illustration the user seeking access may have first requested access based upon an injury to their finger. However, now the user is again seeking to access the key via process 300B but it has been a month and now the central administrator does not believe the user and states that no access will be granted until the user returns to the central office for in person verification.

If however, the central administrator determines to grant access then the central administrator requests additional verification data in process 326. The central administrator upon verifying the additional verification data provides an OTP to the user in process 328, the OTP provided is selected according to the security access provided.

The OTP provided in process 328 is then transferred to process 330 which can either apply a hash process to the OTP or provide it unmodified. This is then applied to a security process 322 along with an access key extracted from the peripheral memory storage device in process 324. From this process flow one of a multiple potential access keys is generated:

SECURITY{H(OTP);(Access Key)}=Key-XX.

For example, access Key31 provided in process 327 provides for unlimited access to all secure information on the peripheral memory storage device. In contrast Key32 provided in process 329 gives access solely to a single directory either predetermined or determined based on the hash process result. Finally in this illustrative embodiment Key33 provided in process 331 gives access to a single file within a single directory, in this embodiment a risk management decision of the central administrator based upon the information present to them by the user is used to determine which access key process to initiate.

For example, for a single file access, the security process is provided with an OTP that has encoded therein the file information for being accessed. Thus the file is dynamically determinable. Alternatively, specific predetermined directories such as email, word processing, marketing, my music, my pictures, etc. each has specific access codes associated therewith. Advantageously, when a user leaves their peripheral memory storage device at home, an OTP is available allowing their spouse or child to access a specific directory/file and to email this to the user at their office. No other rights are granted. Advantageously this is optionally provided with a time limit.

Further, optionally, access is limited by the security process to secured data. Here, instead of providing the spouse or child with access to the file, access is provided to an encrypted version of the file suitable for transmission to the office and for being decoded there.

In another example, when a large amount of secure information must be obtained from a third-party or several third parties. The user sends the peripheral memory storage device to a first client with an OTP, which simply allows copying of a file to a specific directory and does not allow any other actions to be performed. This may be extended such that the USB memory key is circulated amongst a plurality of individuals, each of whom is provided a different OTP allowing them different access/use rights according to requirements. Thus, each party reads only permitted data and stores data only within permitted directories of the peripheral memory storage device.

In another example, a user contacts the office because they have forgotten a password and will be at the office again tomorrow. Here the user wants access to make some notes, amendments, or work on documents for a short period of time, for example prior to a flight. Here an OTP giving an hour's access, which itself is optionally further limited.

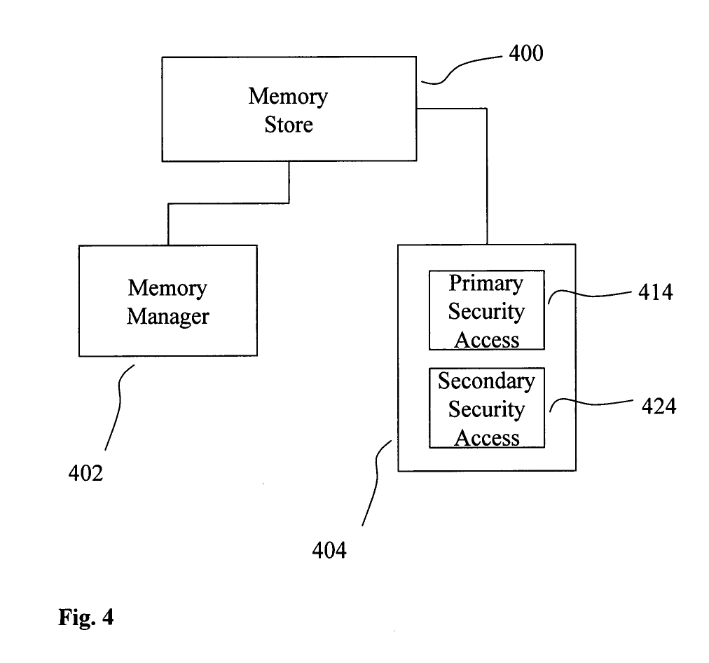

Referring to FIG. 4, shown is a simplified block diagram of a peripheral memory storage device. A memory store 400 is provided. Coupled with the memory store are memory manager 402 and security processor 404. Security processor 404 comprises a primary security access process block 414 and a second security access block 424. The primary security access block 414 is for providing typical secure access to data stored within the peripheral memory storage device. The second security access block is for in cooperation with a one time password generation process providing temporary access in the absence of the primary security access.

Within the security processor 404 is provided a data access restriction element in the form of a key. Absent the key, data is irretrievable from the memory store 400. Alternatively, due to the closed system nature of the peripheral memory storage device, the security process is able to monitor and restrict access to data within the memory store 400 of the peripheral memory storage device. As such, there are numerous methods for securing the data within the memory store.

Accordingly, the primary security access block is used during normal use of the peripheral memory storage device and the second security access block is for use when the primary security access block is other than suitable for providing access.

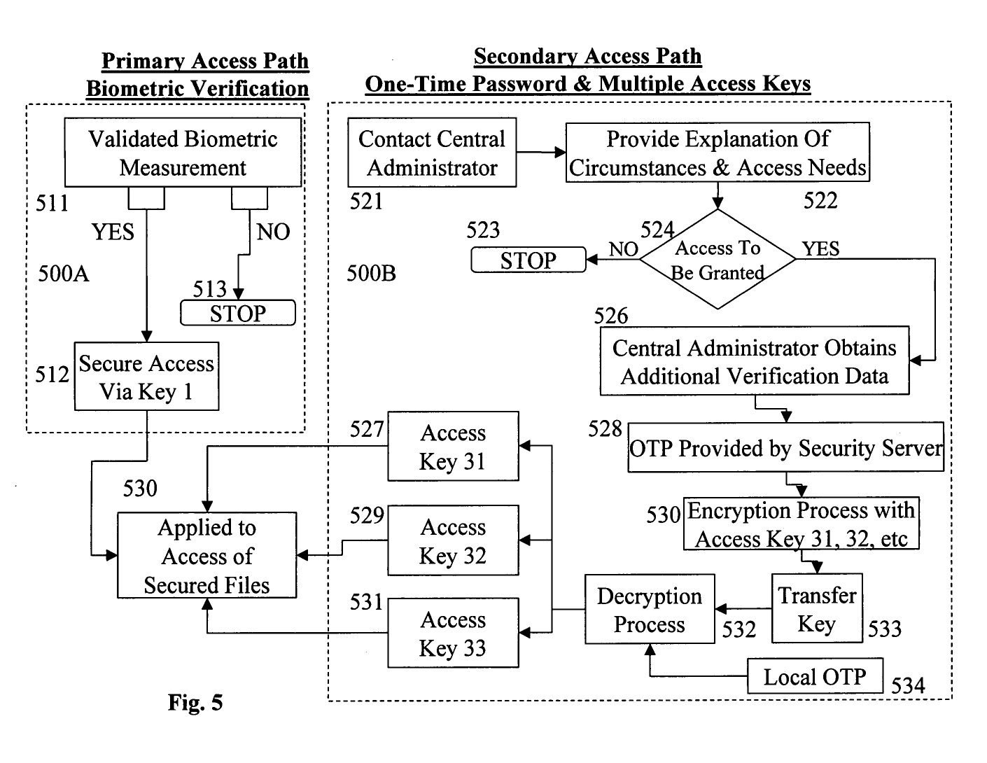

Referring to FIG. 5 shown is an exemplary simplified flow diagram for implementing a second embodiment of the invention illustrating the use of a one-time password and multiple access keys.

A first process 500A represents the normal path of accessing a peripheral memory storage device in the form of a USB memory key enabled with fingerprint verification. Here the user provides a fingerprint sample at 511 wherein access rights of the user for the secure data are determined. An invalid verification of the provided fingerprint sample against stored template data results in a stop process 513. An authenticated fingerprint results in extracting an access key “key 1” in process 512 which is then provided to result in access to the secured files in process 530.

If the validation process 511 results in the stop process 513, for example because of temporary or permanent damage to a fingertip or fingerprint sensor, then the user initiates process 500B by contacting a central administrator or a central administrator process in process 521. The user is typically required by the central administrator to provide an explanation of the circumstances and the access required in process 522. The central administrator then determines in process 525 whether to provide access or not. If not then the process stops with process 523. By way of illustration the user seeking access may have first requested access based upon an injury to their finger. However, now the user is again seeking to access the key via process 500B but it has been a month and now the central administrator does not believe the user and states that no access will be granted until the user returns to the central office for in person verification.

If however, the central administrator determines to grant access then the central administrator requests additional verification data in process 526. The central administrator upon verifying the additional verification data obtains an OTP from the security server along with an access key “K” in process 528. In process 530 the OTP and access key “K” are encrypted by an algorithm:

Transfer Key=Encrypt(OTP,K)

where “Encrypt” is the encryption algorithm and “Transfer Key” is the resulting encrypted code to be transferred to the user to provide the granted level, type, and duration of access. The access key “K” selected being based upon the access to the device and information being granted by the central administrator.

The “Transfer Key” is provided to the user in process 533. This access key is then provided to the peripheral memory storage device, which proceeds with decryption process 532, which takes the “Transfer Key” along with the OTP provided locally by the device in process 534. From this process flow one of a multiple potential access keys is generated:

KEY XX=Decrypt(OTP,Transfer Key).

Hence, the access key determined by the central administrator is extracted. For example, the access key “Key31” is provided in process 527 wherein the access key provides unlimited access to all secure information on the peripheral memory storage device. In contrast, the access key “Key32” shown for illustration in a second process 529 gives access solely to a single directory either predetermined or determined based on the security process result. Finally in this illustrative embodiment the access key “Key32” shown for illustration in a third process 531 gives access to a single file within a single directory, in this case a risk management decision of the central administrator based upon the information presented to them by the user. This is used to determine which access key process to initiate.

For example, for a single file access, the security process with the access key additionally decrypts additional data having encoded therein the file information to be accessed. Thus the file is dynamically determinable. Alternatively, specific predetermined directories such as email, word processing, marketing, my music, my pictures, etc. each has specific access codes associated therewith. Advantageously, when a user leaves their peripheral memory storage device at home, an encrypted transfer key can be provided therein generating an OTP and access key allowing their spouse or child to access a specific directory/file and to email this to the user at their office. No other rights are granted. Advantageously this is optionally provided with a time limit.

Further, optionally, access is limited by the security process to secured data. Here, instead of providing the spouse or child with access to the file, access is provided to an encrypted version of the file suitable for transmission to the office and for being decoded there.

In another example, when a large amount of secure information must be obtained from a third-party or several third parties. The user sends the peripheral memory storage device to a first client with an encrypted transfer key, which simply allows copying of a file to a specific directory and does not allow any other actions to be performed. This may be extended such that the USB memory key is circulated amongst a plurality of individuals, each of whom is provided a different transfer key allowing them different access/use rights according to requirements. Thus, each party reads only permitted data and stores data only within permitted directories of the peripheral memory storage device.

In another example, a user contacts the office because they have forgotten a password and will be at the office again tomorrow. Here the user wants access to make some notes, amendments, or work on documents for a short period of time, for example prior to a flight. Here an OTP giving an hour's access, which itself is optionally further limited.

It would be evident that the approach outlined in the above embodiments allows for the flexible management of one-time passwords and access keys according to different circumstances existing at any specific instance wherein they are unable to access the memory storage using the normal security processes. Further the access key to a peripheral memory storage device is useful for limited access when the main access mechanism is temporarily unavailable.

Also it would evident that the approach is ideally suited to a closed system such as a peripheral memory device such as a USB memory stick wherein the entire process is closed as long as the security algorithms run within the peripheral memory device. This being in contrast to prior art solutions, which are open systems in that the key is stored securely but the code to operate and change everything is accessible, and hackable.

Numerous other embodiments may be envisaged without departing from the spirit or scope of the invention.

What is claimed is:

1. A security process comprising:
a one time password access protocol for providing a secondary secure access protocol to a peripheral memory storage device having an existing primary secure access protocol,
the secondary secure access protocol operating independent of the information for initiating the primary secure access protocol and absent exposing information useful for breaching of either the primary secure access protocol or the secondary secure access protocol, the secondary secure access protocol comprising:
contacting a one time password provider comprising at least one of a server and an information technology administrator,
identifying oneself to the one time password provider; and
receiving from the one time password provider a one time password for use with the secondary secure access protocol, the one time password for providing access one time.

2. A method according to claim 1 wherein;
the primary secure access protocol includes verification of at least one of a password, a fingerprint, speech, face, and retina.

3. A method according to claim 1 wherein;
the primary secure access protocol for providing primary access to at least one of the peripheral memory storage device, a host computer to which the peripheral memory storage device is attached, and a remote computer attached to the host computer via a network.

4. A method according to claim 3 wherein;
the secondary secure access protocol for providing secondary access to at least one of the peripheral memory storage device, a host computer to which the peripheral memory storage device is attached, and a remote computer attached to the host computer via a network.

5. A method according to claim 3 wherein;
the primary access to the removable peripheral memory storage device is at least one of a file, a directory, a folder and a partition.

6. A method according to claim 4 wherein;
the secondary access to the removable peripheral memory storage device is at least one of a file, a directory, a folder and a partition.

7. A method according to claim 4 wherein;
the secondary access has different rights than the primary access.

8. A method according to claim 7 wherein;
the secondary access is restricted to at least one of a file, directory, folder or partition on the peripheral memory storage device.

9. A method according to claim 1 wherein;
the secondary secure access protocol provides secure access for at least one of unlimited duration, a limited time, limited access operations, limited file type, write-only operations, and read-only operations.

10. A method according to claim 1 wherein;
the secondary secure access protocol provides secure access in dependence upon the one-time password provided to the one time password protocol.

11. A method according to claim 10 wherein;
the secondary secure access protocol generates a new access key.

12. A method according to claim 11 wherein;
the new access key is obtained by a security process utilizing at least one of the one-time password, a secure access key, a hashing process, a prior password and hidden security data.

13. A method according claim 11 wherein;
a further new access key cannot be obtained by correlating the current one-time password with any combination of at least the original password and at least one of a number of previously provided one-time passwords.

14. A method according to claim 1 wherein;
the peripheral memory storage device is at least one of a USB memory device, a flash-memory card, a wireless enabled memory device, and a wireless enabled device.

15. A method according to claim 1 wherein;
the one time password for the one time password protocol is provided to the user after verification of an additional security check.

16. A method according to claim 15 wherein;
the one time password is provided to the user by means of at least one of a telephone call, a facsimile transmission, an electronic message and a written message.

17. A method according to claim 15 wherein;
the one-time password is valid for a limited duration after it's release to the user.

18. A method according to claim 1 wherein;
the peripheral memory storage device operates a closed system.

19. A security process comprising:
a one time password access protocol for providing a secondary secure access protocol to a peripheral memory storage device having an existing primary secure access protocol,
the secondary secure access protocol operating independent of the information for initiating the primary secure access protocol and absent communication between the peripheral memory storage device and an external electronic system, the secondary secure access protocol comprising:
contacting a one time password provider comprising at least one of a server and an information technology administrator,
identifying oneself to the one time password provider; and
receiving from the one time password provider a one time password for use with the secondary secure access protocol, the one time password for providing access one time.

20. A method according to claim 19 wherein;
the primary secure access protocol includes verification of at least one of a password, a fingerprint, speech, face, and retina.

21. A method according to claim 19 wherein;
the primary secure access protocol for providing primary access to at least one of the peripheral memory storage device, a host computer to which the peripheral memory storage device is attached, and a remote computer attached to the host computer via a network.

22. A method according to claim 21 wherein;
the secondary secure access protocol for providing secondary access to at least one of the peripheral memory storage device, a host computer to which the peripheral memory storage device is attached, and a remote computer attached to the host computer via a network.

23. A method according to claim 21 wherein;
the primary access to the removable peripheral memory storage device is at least one of a file, a directory, a folder and a partition.

24. A method according to claim 22 wherein;
the secondary access to the removable peripheral memory storage device is at least one of a file, a directory, a folder and a partition.

25. A method according to claim 22 wherein;
the secondary access has different rights than the primary access.

26. A method according to claim 25 wherein;
the secondary access is restricted to at least one of a file, directory, folder or partition on the peripheral memory storage device.

27. A method according to claim 19 wherein;
the secondary secure access protocol provides secure access for at least one of unlimited duration, a limited time, limited access operations, limited file type, write-only operations, and read-only operations.

28. A method according to claim 19 wherein;
the secondary secure access protocol provides secure access in dependence upon the one-time password provided to the one time password protocol.

29. A method according to claim 28 wherein;
the secondary secure access protocol generates a new access key.

30. A method according to claim 29 wherein;
the new access key is obtained by a security process utilizing at least one of the one-time password, a secure access key, a hashing process, a prior password and hidden security data.

31. A method according claim 29 wherein;
a further new access key cannot be obtained by correlating the current one-time password with any combination of at least the original password and at least one of a number of previously provided one-time passwords.

32. A method according to claim 19 wherein;
the peripheral memory storage device is at least one of a USB memory device, a flash-memory card, a wireless enabled memory device, and a wireless enabled device.

33. A method according to claim 19 wherein;
the one time password for the one time password protocol is provided to the user after verification of an additional security check.

34. A method according to claim 33 wherein;
the one time password is provided to the user by means of at least one of a telephone call, a facsimile transmission, an electronic message and a written message.

35. A method according to claim 33 wherein;
the one-time password is valid for a limited duration after it's release to the user.

36. A method according to claim 19 wherein;
the peripheral memory storage device operates a closed system.

37. A security process comprising:
a transfer key access protocol for providing a secondary secure access protocol to a peripheral memory storage device having an existing primary secure access protocol, the secondary secure access protocol operating independent of the information for initiating the primary secure access protocol and absent at least one of exposing information useful for breaching of either the primary secure access protocol or the secondary secure access protocol, and absent communication between the peripheral memory storage device and an external electronic system, the secondary secure access protocol comprising:
contacting an access key provider comprising at least one of a server and an information technology administrator,
identifying oneself to the access key provider; and
receiving from the access key provider a transfer key for use with the secondary secure access protocol, the transfer key for providing an access key, the access key for accessing the peripheral memory storage device.

38. A method according to claim 37 wherein;
the primary secure access protocol includes verification of at least one of a password, a fingerprint, speech, face, and retina.

39. A method according to claim 37 wherein;
the primary secure access protocol for providing primary access to at least one of the peripheral memory storage device, a host computer to which the peripheral memory storage device is attached, and a remote computer attached to the host computer via a network.

40. A method according to claim 39 wherein;
the secondary secure access protocol for providing secondary access to at least one of the peripheral memory storage device, a host computer to which the peripheral memory storage device is attached, and a remote computer attached to the host computer via a network.

41. A method according to claim 39 wherein;
the primary access to the removable peripheral memory storage device is at least one of a file, a directory, a folder and a partition.

42. A method according to claim 40 wherein;
the secondary access to the removable peripheral memory storage device is at least one of a file, a directory, a folder and a partition.

43. A method according to claim 40 wherein;
the secondary access has different rights than the primary access.

44. A method according to claim 43 wherein;
the secondary access is restricted to at least one of a file, directory, folder or partition on the peripheral memory storage device.

45. A method according to claim 37 wherein;
the secondary secure access protocol provides secure access for at least one of unlimited duration, a limited time, limited access operations, limited file type, write-only operations, and read-only operations.

46. A method according to claim 37 wherein;
the secondary secure access protocol provides secure access in dependence upon the transfer key provided.

47. A method according to claim 46 wherein;
the secondary secure access protocol generates a new access key from the transfer key.

48. A method according to claim 47 wherein;
the new access key is obtained by a security process utilizing at least one of the one-time password, a secure access key, a hashing process, a prior password, a one time password and hidden security data.

49. A method according claim 47 wherein;
a further new access key cannot be obtained by correlating the current access key or transfer key with any combination of at least one of the original password, one of a number of one time passwords, at least one of a number of previously provided transfer keys, and at least one of a number of previous access keys.

50. A method according to claim 37 wherein;
the peripheral memory storage device is at least one of a USB memory device, a flash-memory card, a wireless enabled memory device, and a wireless enabled device.

51. A method according to claim 37 wherein;
the transfer key for the secondary access protocol is provided to the user after verification of an additional security check.

52. A method according to claim 51 wherein;
the transfer key is provided to the user by means of at least one of a telephone call, a facsimile transmission, an electronic message and a written message.

53. A method according to claim 51 wherein;
at least one of the transfer key, the one-time password used to generate a transfer key, and the access key used to generate a transfer key are valid for a limited duration after it's release to the user.

54. A method according to claim 37 wherein;
the peripheral memory storage device operates a closed system.
